(19) United States
(12) Patent Application Publication
(10) Pub. No.: US 2020/0130273 A1
(43) Pub. Date: Apr. 30, 2020

(54) DEVICE FOR MANUFACTURING THREE-DIMENSIONAL SHAPED OBJECT AND METHOD FOR MANUFACTURING THREE-DIMENSIONAL SHAPED OBJECT

(71) Applicant: Seiko Epson Corporation, Tokyo (JP)

(72) Inventor: Akihiko TSUNOYA, Okaya (JP)

(21) Appl. No.: 16/660,988

(22) Filed: Oct. 23, 2019

(30) Foreign Application Priority Data
Oct. 24, 2018 (JP) 2018-200111

(51) Int. Cl. B29C 64/209; B29C 64/118; B29C 64/194; B33Y 10/00; B33Y 30/00

(52) U.S. Cl. CPC B29C 64/209; B29C 64/118; B33Y 30/00; B33Y 10/00; B29C 64/194

(57) ABSTRACT

A device for manufacturing a three-dimensional shaped object for manufacturing a three-dimensional shaped object by laminating layers includes melting units melting a thermoplastic constituent material, an ejector having a nozzle and moving while ejecting the constituent material in a molten state from the nozzle to form the layers, and an irregularity formation portion forming an irregularity on a surface in a lamination direction of the layers by coming into contact with the constituent material in the molten state.

The present application is based on, and claims priority from, JP Application Serial Number 2018-200111, filed Oct. 24, 2018, the disclosure of which is hereby incorporated by reference herein in its entirety.

### BACKGROUND

### 1. Technical Field

The present disclosure relates to a device for manufacturing a three-dimensional shaped object and a method for manufacturing a three-dimensional shaped object.

### 2. Related Art

In the related art, various device for manufacturing the three-dimensional shaped object are in use. Among them, there is a device for manufacturing a three-dimensional shaped object for manufacturing a three-dimensional shaped object by laminating layers using a fluid constituent material.

For example, JP-A-2015-212042 discloses a three-dimensional modeling device configured to form layers having a level difference by changing an ejection amount of molding material, such as partially changing the ejection amount of the molding material.

When a three-dimensional shaped object is manufactured by lamination of layers, adhesion failure between respective layers occurs in some cases. If the adhesion failure between the respective layers occurs, the three-dimensional shaped object is deformed or strength thereof weakens in some cases. The three-dimensional modeling device disclosed in JP-A-2015-212042 can form layers having a level difference so that an increase of a contact area between the laminated layers can generate an anchor effect and the adhesion failure can be suppressed. However, it is necessary to execute a complicated ejection control such as a partial change of an ejection amount of the molding material. Therefore, it is desirable to suppress the adhesion failure between respective layers without executing a complicated ejection control when a three-dimensional shaped object is manufactured by lamination of layers.

### SUMMARY

A device for manufacturing a three-dimensional shaped object according to an aspect of the present disclosure is a device for manufacturing a three-dimensional shaped object for manufacturing a three-dimensional shaped object by laminating layers. The manufacturing device includes a melting unit melting a thermoplastic constituent material, an ejector having a nozzle and moving while ejecting the constituent material in a molten state from a nozzle to form the layers and an irregularity formation portion forming an irregularity on a surface in the lamination direction of the layers by coming contact with the constituent material in the molten state.

### BRIEF DESCRIPTION OF THE DRAWINGS

FIG. 1 is a schematic configuration view showing a configuration of a device for manufacturing a three-dimensional shaped object according to an embodiment example 1 of the present disclosure.

FIG. 2 is a schematic view showing a flat screw of the device for manufacturing a three-dimensional shaped object according to the embodiment example 1 of the present disclosure.

FIG. 3 is a schematic view showing a state in which a flat screw of the device for manufacturing a three-dimensional shaped object according to the embodiment example 1 of the present disclosure is filled with a constituent material.

FIG. 4 is a schematic view showing a barrel of the device for manufacturing a three-dimensional shaped object according to the embodiment example 1 of the present disclosure.

FIG. 5 is a schematic bottom view showing an ejector of the device for manufacturing a three-dimensional shaped object according to the embodiment example 1 of the present disclosure.

FIG. 6 is a schematic side sectional view showing the ejector of the device for manufacturing a three-dimensional shaped object according to the embodiment example 1 of the present disclosure and shows a state immediately before an nth layer is formed on an (n-1)th layer.

FIG. 7 is a flowchart of a method for manufacturing a three-dimensional shaped object executed with the device for manufacturing the three-dimensional shaped object according to the embodiment example 1 of the present disclosure.

FIG. 8 is a schematic bottom surface view showing the ejector of the device for manufacturing a three-dimensional shaped object according to an embodiment example 2 of the present disclosure.

FIG. 9 is a schematic side sectional view showing the ejector of the device for manufacturing a three-dimensional shaped object according to the embodiment example 2 of the present disclosure and shows the state immediately before the nth layer is formed on the (n-1)th layer.

FIG. 10 is a schematic side sectional view showing the ejector of the device for manufacturing a three-dimensional shaped object according to an embodiment example 3 of the present disclosure and shows the state immediately before the nth layer is formed on the (n-1)th layer.

FIG. 11 is a schematic side sectional view showing the ejector of the device for manufacturing a three-dimensional shaped object according to an embodiment example 4 of the present disclosure and shows the state immediately before the nth layer is formed on the (n-1)th layer.

FIG. 12 is a schematic side sectional view showing the ejector of the device for manufacturing a three-dimensional shaped object according to an embodiment example 5 of the present disclosure and shows the state immediately before the nth layer is formed on the (n-1)th layer.

### DESCRIPTION OF EXEMPLARY EMBODIMENTS

First, the present disclosure will be schematically described.

A device for manufacturing a three-dimensional shaped object according to a first aspect of the present disclosure is a device for manufacturing a three-dimensional shaped object for manufacturing a three-dimensional shaped object by laminating layers. The manufacturing device includes a melting unit melting a thermoplastic constituent material, an ejector having a nozzle and moving while ejecting the constituent material in a molten state from the nozzle to form the layers and an irregularity formation portion forming an irregularity on a surface in a lamination direction of the layers by coming contact with the constituent material in the molten state.

According to the aspect, the irregularity formation portion forming the irregularity on the surface in the lamination direction of the layers is included so that it is possible to suppress adhesion failure by increasing an adhesion force due to the anchor effect generated between the material ejected from the nozzle and the previous layer already formed. Further, the irregularity formation portion is configured to come into contact with the constituent material in the molten state so that it is possible to easily provide the irregularity in the constituent material in a soft state and there is also no need to execute a complicated ejection control. Therefore, it is possible to suppress the adhesion failure between the respective layers at the time of manufacturing the three-dimensional shaped object by laminating layers without executing a complicated ejection control.

The device for manufacturing the three-dimensional shaped object according to a second aspect of the present disclosure is directed to the first aspect, in which the ejector is provided with a projection as the irregularity formation portion around the nozzle and the projection forms the irregularity by coming into contact with the surface as the ejector is moved to form the layer.

According to the aspect, the projection as the irregularity formation portion is provided around the nozzle of the ejector. Therefore, it is possible to reduce the distance between the nozzle and the irregularity formation portion and to particularly easily form the irregularity at a desired position.

The device for manufacturing the three-dimensional shaped object according to a third aspect of the present disclosure is directed to the first aspect, in which the irregularity formation portion in which a projection is formed is provided around the ejector, and the irregularity formation portion forms the irregularity by causing the projection to come into contact with the surface as the ejector is moved to form the layer.

According to the aspect, the irregularity formation portion is provided separately from the ejector so that it is possible to easily adjust the position of the projection with respect to the layer in which the irregularity is formed.

The device for manufacturing the three-dimensional shaped object according to a fourth aspect of the present disclosure is directed to the second or third aspect, in which the projection is subjected to a surface treatment for suppressing adhesion of the constituent material in the molten state.

According to the aspect, the projection is subjected to the surface treatment for suppressing the adhesion of the constituent material in the molten state so that it is possible to suppress the adhesion of the constituent material to the projection as the irregularity is formed in the layer.

The device for manufacturing the three-dimensional shaped object according to a fifth aspect of the present disclosure is directed to any one of the second to fourth aspects, in which the projection is formed in a curved surface.

According to the aspect, the projection is formed in a curved surface so that it is possible to reduce the resistance at the time of forming the irregularity in the layer.

The device for manufacturing the three-dimensional shaped object according to a sixth aspect of the present disclosure is directed to any one of the second to fifth aspects, in which the projection widens toward a tip portion.

According to the aspect, since the projection widens toward the tip portion, it is possible to particularly strengthen the adhesion force between the respective layers by the anchor effect and to effectively suppress the adhesion failure between the respective layers.

The device for manufacturing the three-dimensional shaped object according to a seventh aspect of the present disclosure is directed to any one of the second to fifth aspects, in which the projection narrows toward the tip portion.

According to the aspect, since the projection narrows toward the tip portion, it is possible to easily manufacture the projection.

The device for manufacturing the three-dimensional shaped object according to an eighth aspect of the present disclosure is directed to any one of the second to seventh aspects, in which the outer diameter of the projection in a direction intersecting with the protrusion direction of the projection is narrower than the inner diameter of the nozzle.

According to the aspect, the outer diameter of the projection in a direction intersecting with the protrusion direction of the projection is narrower than the inner diameter of the nozzle so that it is possible to form the irregularity on the fine surface of respective layers and to obtain a three-dimensional shaped object of high definition and high strength even when a high-definition three-dimension object is manufactured.

The device for manufacturing the three-dimensional shaped object according to a ninth aspect of the present disclosure is directed to any one of the second to seventh aspects, in which the device includes, as the projection, a first projection and a second projection which is farther from the nozzle than the first projection and of which the length in the projection direction is longer than the first projection.

If the constituent material in the molten state flows in the ejection width direction, the sectional shape is rounded and the constituent material in the rounded shape is adjoined so that a concern that a space is generated in the adjoining portion arises. According to the present aspect, it is possible to effectively suppress the rounding of the end portion in the ejection width direction caused by an excessive flowing of the constituent material in the molten state in the ejection width direction at the time of forming the layers and to suppress the generation of the space in the portion in which the constituent materials adjoin each other.

A method for manufacturing the three-dimensional shaped object according to a tenth aspect of the present disclosure is a method for manufacturing a three-dimensional shaped object for manufacturing a three-dimensional shaped object by laminating layers and includes a melting step of melting a thermoplastic constituent material, a layer formation step of forming the layer by using the ejector moving while ejecting the constituent material in the molten state from the nozzle, and the irregularity formation step of forming the irregularity on the surface of the layers in the lamination direction by causing the irregularity formation portion to come into contact with the constituent material in the molten state.

According to the aspect, the irregularity formation step of forming an irregularity on the surface of the layers in the lamination direction is included so that it is possible to suppress the adhesion failure by increasing the adhesion force due to the anchor effect between the respective layers. Further, since the irregularity formation portion is configured to come into contact with the constituent material in the molten state, it is possible to easily provide the irregularity in the constituent material in the soft state, and there is also no need to execute a complicated ejection control. Therefore, it is possible to suppress the adhesion failure between the respective layers at the time of manufacturing the three-dimensional shaped object by laminating the layers without executing a complicated ejection control.

The method for manufacturing the three-dimensional shaped object according to an eleventh aspect of the present disclosure is directed to the tenth aspect, in which the ejector is provided with the projection around the nozzle and, in the irregularity formation step, the projection is caused to come into contact with the surface to form the irregularity as the ejector is moved in the layer formation step.

According to the aspect, the projection as the irregularity formation portion is provided around the nozzle of the ejector. Therefore, it is possible to reduce the distance between the nozzle and the irregularity formation portion to particularly easily form the irregularity at the desired positions.

The method for manufacturing the three-dimensional shaped object according to a twelfth aspect of the present disclosure is directed to the tenth aspect, in which the irregularity formation portion in which the projection is formed is provided around the ejector and, in the irregularity formation step, the projection is caused to come into contact with the surface to form the irregularity as the ejector is moved in the layer formation step.

According to the aspect, since the irregularity formation portion is included separately from the ejector, it is possible to easily adjust the position of the projection with respect to the layer in which the irregularity is formed.

In the following, embodiments according to the present disclosure will be described with reference to the attached drawings.

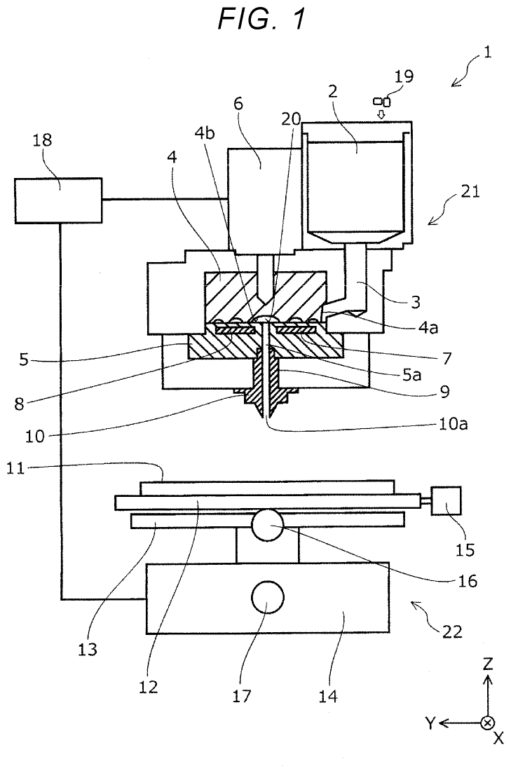

### Embodiment Example 1 (FIGS. 1 to 7)

First, an outline of the manufacturing device 1 of the three-dimensional shaped object according to the embodiment example 1 of the present disclosure will be described with reference FIGS. 1 to 4.

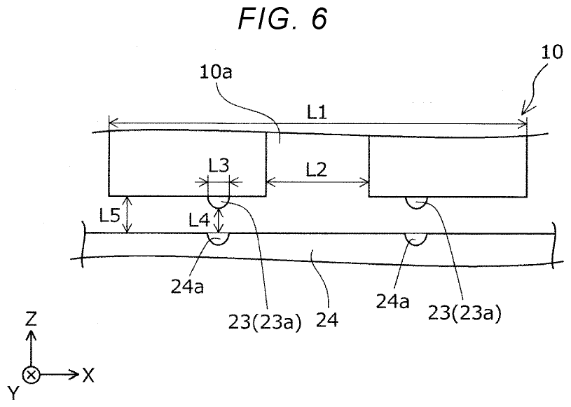

Here, the X-direction in the drawing is the horizontal direction and the Y-direction is the horizontal direction orthogonal to the X-direction. Further, the Z-direction is the vertical direction and corresponds to the lamination direction of the layer 24 of the constituent material shown in FIG. 6.

“Three-dimensional modeling” in the present specification indicates the formation of a so-called three-dimensional shaped object and includes the formation of even a so-called two-dimensional shape having a thickness, for example, such as a flat plate shape configured with the layer 24 of one layer, for example. Further, to “support” means not only supporting from the lower side but also supporting from the lateral side and, in some cases, supporting from the upper side.

As shown in FIG. 1, the manufacturing device 1 of the three-dimensional shaped object according to the present embodiment example includes a hopper 2 accommodating a pellet as the constituent material constituting the three-dimensional shaped object. The pellet 19 accommodated in the hopper 2 is supplied to a circumference surface 4a of a substantially cylindrical flat screw 4 through a supply tube 3.

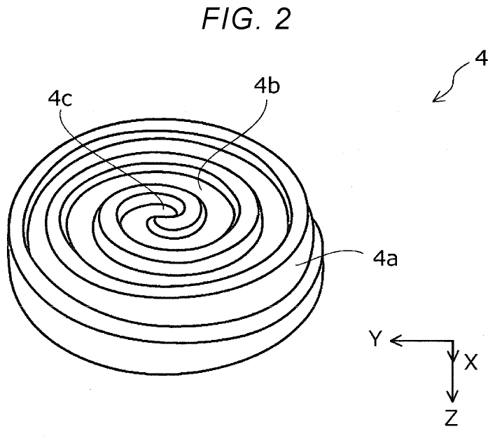

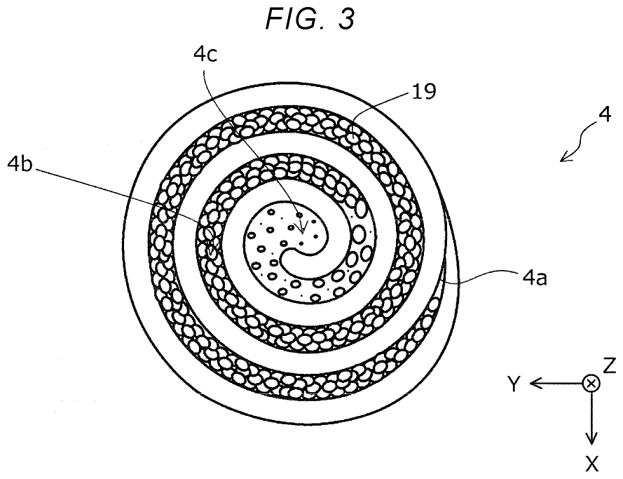

As shown in FIG. 2, a spiral notch 4b extending from the circumference surface 4a to a center portion 4c is formed on a bottom surface of the flat screw 4. Therefore, as shown in FIG. 3, the pellet 19 is fed from the circumference surface 4a to the center portion 4c as the flat screw 4 is rotated by a motor 6 shown in FIG. 1, with the Z-direction serving as a rotation axis.

As shown in FIG. 1, barrels 5 are provided at a predetermined interval at a position facing the bottom surface of the flat screw 4. Heaters 7 and 8 are provided in the vicinity of the upper surface of the barrel 5. With the flat screw 4 and the barrel 5 configured as described above, by the rotation of the flat screw 4, the pellet 19 is supplied to a space portion 20 by the notch 4b, which is formed between the bottom surface of the flat screw 4 and the upper surface of the barrel 5, and moves from the circumference surface 4a to the center portion 4c. When the pellet 19 moves in the space portion 20 by the notch 4b, the pellet 19 is melted, that is, plasticized, by the heat of the heaters 7 and 8 and, further, is pressurized as the pellet 19 moves in the narrow space portion 20. Thus, the fluid constituent material is ejected from a nozzle 10a as the pellet 19 is plasticized.

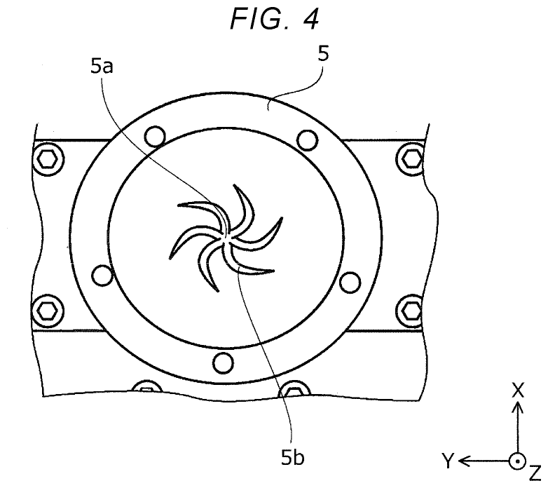

As shown in FIGS. 1 and 4, a moving path 5a of the constituent material which is the molten pellet 19 is formed in the center portion of the barrel 5 in a plan view. As shown in FIG. 1, the moving path 5a is connected to the nozzle 10a of the ejector 10 ejecting the constituent material. As shown in FIG. 4, a plurality of grooves 5b which is connected to the moving path 5a are formed on the upper surface of the barrel 5, and the constituent material is easily gathered toward the moving path 5a.

The ejector 10 is configured to continuously eject the constituent material in a fluid state from the nozzle 10a. As shown in FIG. 1, the ejector 10 is provided with a heater for making the constituent material have the desired viscosity. The constituent material ejected from the ejector 10 is linearly ejected. Then, the constituent material is linearly ejected from the ejector 10 to form the layer 24 of the constituent material. The detailed configuration of the ejector 10 which is a principal portion of the manufacturing device 1 of the three-dimensional shaped object according to the present embodiment example will be described below.

In the manufacturing device 1 of the three-dimensional shaped object according to the present embodiment example, the hopper 2, the supply tube 3, the flat screw 4, the barrel 5, the motor 6, the ejector 10, and the like form the ejection unit 21. The manufacturing device 1 of the three-dimensional shaped object according to the present embodiment example is configured to include one ejection unit 21 ejecting the constituent material but may be configured to include a plurality of the ejection units 21 ejecting the constituent material and may be configured to include an ejection unit 21 ejecting a support material. Here, the support material is a material for forming a layer of the support material for supporting the layer 24 of the constituent material.

Further, as shown in FIG.1, the manufacturing device 1 of the three-dimensional shaped object according to the present embodiment example includes a stage unit 22 for placing the layer 24 formed by the ejection from the ejection unit 21. The stage unit 22 includes a plate 11 on which the layer 24 is actually placed. Further, the stage unit 22 includes a first stage 12 on which the plate 11 is placed and which is configured to change the positions in the Y-direction by the driving of a first driver 15. Further, the stage unit 22 includes a second stage 13 on which the first stage 12 is placed and which is configured to change positions in the X-direction by the driving of a second driver 16. The stage unit 22 includes a base portion 14 configured to change positions of the second stage 13 in the Z-direction by the driving of a third driver 17.

As shown in FIG. 1, the manufacturing device 1 of the three-dimensional shaped object according to the present embodiment example is electrically coupled to a control unit 18 controlling various driving of the ejection unit 21 and various driving of the stage unit 22.

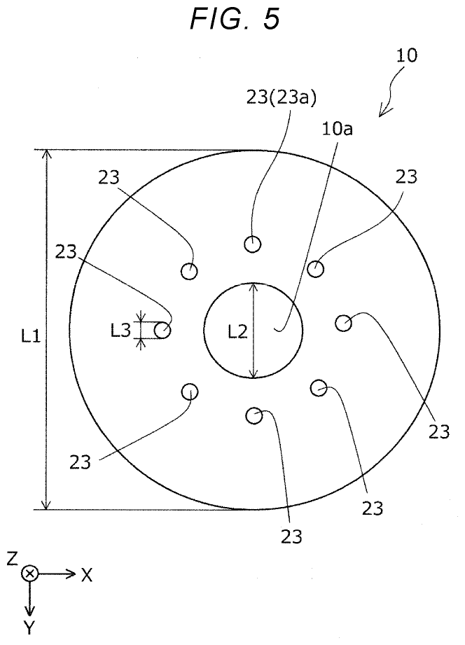

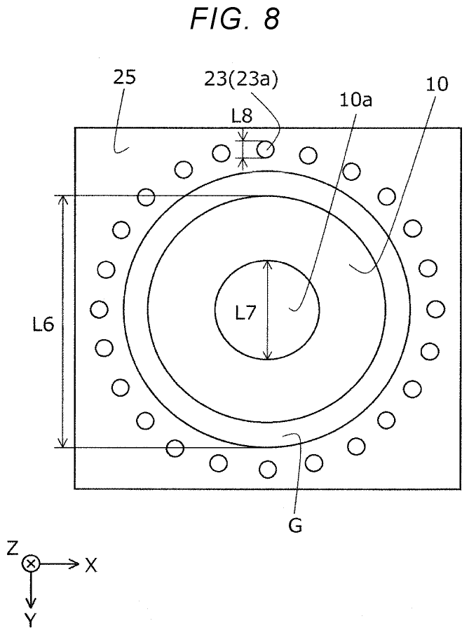

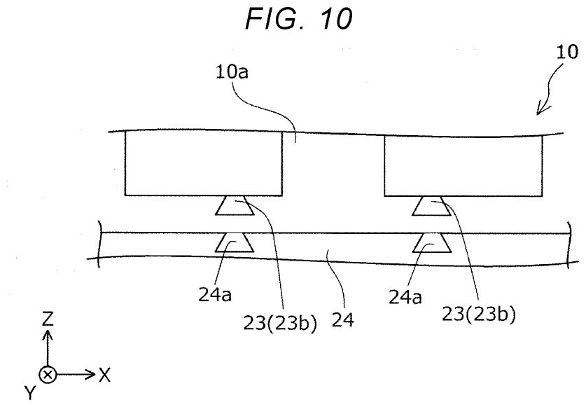

Next, the ejector 10 which is the principal portion of the manufacturing device 1 of the three-dimensional shaped object according to the present embodiment example will be described with reference to FIGS. 5 and 6. In FIGS. 5 and 6, in order to make it easy to visualize the shape of the projection 23 to be described below, the ratios of the size of the respective constituting members are altered from the actual ones. Similarly, in the FIGS. 8 and 10 to be described below, in order to make it easy to visualize the shape of the projection 23, the ratios of the size of the respective constituting members are altered from the actual ones.

As shown in FIGS. 5 and 6, in the ejector 10 according to the present embodiment example, the projection 23 is formed around the nozzle 10a to come into contact with the layer 24 as the ejector 10 moves at the time of layer formation. In other words, the manufacturing device 1 of the three-dimensional shaped object according to the present embodiment example includes the projection 23 as the irregularity formation portion forming the irregularity on the surface in the lamination direction of the layer 24 by coming into contacting with the constituent material in the molten state. FIG. 6 shows the state immediately before the layer 24 of nth layer is formed on the layer 24 of the (n-1) th layer, and a recess portion 24a, formed by come into contact with the projection 23 when the manufacturing device 1 of the three-dimensional shaped object according to the present embodiment example forms the layer 24 of the (n-1)th layer, is formed on the surface of the layer 24 of the (n-1)th layer.

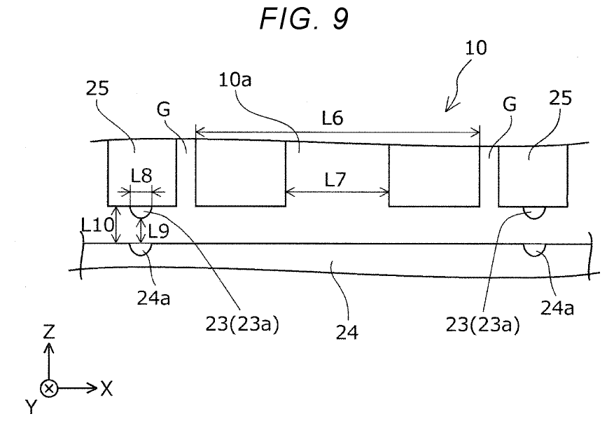

The projection 23 and the recess portion 24a in the layer 24 of the (n-1)th layer are disposed at the positions aligned in the lamination direction in FIG. 6, and it is easy to understand that the recess portion 24a is formed by the projection 23. In fact, it is fully possible that the projection 23 and the recess portion 24a in the layer 24 of the (n-1)th layer are disposed at positions not aligned in the lamination direction. The same applies to the FIGS. 9 to 12 to be described below.

As shown in FIG.5, in the ejector 10 according to the present embodiment example, a total of eight projections 23 are formed around the nozzle 10a at the intervals of 45° with respect to the center of the nozzle 10a. Therefore, when the manufacturing device 1 of the three-dimensional shaped object according to the present embodiment example is used to form the layer 24, a plurality of projections 23 among the eight projections 23 come into contact with the layer 24. That is, as many as the number of recess portions 24a in coming into contact with the projections 23 are formed. FIG. 6 shows only two of the recess portions 24a formed by coming into contact with the plurality of projections 23.

The irregularity is formed by the formation of a plurality of recess portions 24a in the layer 24 so that the frictional force between the respective layers increases and the adhesion force by the anchor effect strengthens. Further, the constituent material ejected when the respective layers are formed easily spreads in the ejection width direction, the overall roundness of the ejected constituent material by the surface tension is reduced, and it is possible to reduce the generation of a space in the adjoining portion of the ejected constituent material. Here, the “ejection width direction” is a direction intersecting with the lamination direction and also intersecting with the moving direction of the ejector 10 at the time of layer formation.

Here, to summarize for now, the manufacturing device 1 of the three-dimensional shaped object according to the present embodiment example is a device for manufacturing a three-dimensional shaped object for manufacturing a three-dimensional shaped object by laminating the layer 24. The heaters 7, 8, and 9 as a melting unit melting the pellet 19 which is the thermoplastic constituent material are included. Further, the nozzle 10a is provided and the ejector 10 ejecting the constituent material in the molten state from the nozzle 10a while moving in the direction intersecting with the lamination direction to form the layer 24 is included. Further, the projection 23 as the irregularity formation portion forming the irregularity on the surface in the lamination direction of the layer 24 by coming into contact with the constituent material in the molten state is included.

As described above, the manufacturing device 1 of the three-dimensional shaped object according to the present embodiment example includes the projection 23 forming the irregularity on the surface in the lamination direction of the layer 24 so that it is possible to suppress the adhesion failure by increasing the adhesion force due to the anchor effect generated between the constituent material ejected from the nozzle 10a and the previous layer already formed. Further, in the manufacturing device 1 of the three-dimensional shaped object according to the present embodiment example, the projection 23 is configured to come into contact with the constituent material in the molten state so that it is possible to easily provide the irregularity in the constituent material in a soft state and there is also no need to execute a complicated ejection control. Therefore, in the manufacturing device 1 of the three-dimensional shaped object according to the present embodiment example, it is possible to suppress the adhesion failure between respective layers when the three-dimensional shaped object is manufactured by the lamination of the layer 24 without executing a complicated ejection control.

Here, as shown in FIGS. 5 and 6, in the manufacturing device 1 of the three-dimensional shaped object according to the present embodiment example, the projection 23 is a semicircular projection 23a, in other words, is formed in a curved surface. In this way, the projection 23 is formed in a curved surface so that it is possible to reduce resistance at the time of forming the irregularity in the layer 24. In the present embodiment example, the projection 23 has a semicircular shape, and the configuration of “being formed in a curved surface” is not limited to a semicircular shape. Further, “semicircle” means not only a semicircle of a true circle but also a semicircle of an ellipse.

Further, the projection 23 is semicircular, and thus, is configured to narrow toward the tip portion. In this way, the projection 23 is configured to narrow toward the tip portion so that the manufacturing of the projection 23 is simplified.

Here, the size of the ejector 10 according to the present embodiment example will be described. The outer diameter length L1 of the ejector 10 is 2 mm. The inner diameter L2 of the nozzle 10a is 200 μm. In the projection 23, both the length in the protrusion direction corresponding to the lamination direction and the length L3 in the direction intersecting with the protrusion direction are 50 μm. The interval L4 between the tip of the projection 23 immediately before the layer 24 of the nth layer is formed on the surface of the layer 24 of the (n-1)th layer and the layer 24 of the (n-1) th layer is 100 μm, and the interval L5 between the ejector 10 and the layer 24 of the (n-1) th layer is 150 μm. The interval L5 between the ejector 10 and the layer 24 of the (n-1) th layer corresponds to the thickness of the respective layers of the layer 24.

As described above, in the manufacturing device 1 of the three-dimensional shaped object according to the present embodiment example, the outer diameter of the projection in the direction intersecting with the protrusion direction of the projection 23 is 50 μm, narrower than 200 μm which is the inner diameter of the nozzle 10a. Therefore, for example, it is possible to form the irregularity on the fine surface of the respective layers and to obtain a three-dimensional shaped object of high-definition and high-strength even when a high-definition three-dimensional shaped object is manufactured.

In the manufacturing device 1 of the three-dimensional shaped object according to the present embodiment example, each projection 23 is subjected to a surface treatment for suppressing the adhesion of the constituent material in the molten state. Therefore, the manufacturing device 1 of the three-dimensional shaped object according to the present embodiment example is configured to suppress the adhesion of the constituent material to the projection 23 as the irregularity is formed in the layer 24. The projection 23 is coated with fluorine in the present embodiment example, and the “surface treatment” is not limited to the coating of a foreign material such as the fluorine and the like. In addition to coating the surface of the projection 23, the surface of the projection 23 may be shaped so as to be difficult for the constituent material to adhere to.

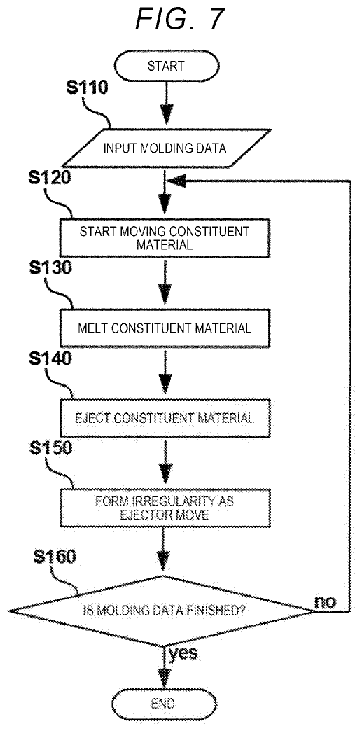

Next, the method for manufacturing the three-dimensional shaped object executed with the manufacturing device 1 of the three-dimensional shaped object according to the present embodiment example will be described with reference to a flowchart of FIG. 7.

In the method for manufacturing the three-dimensional shaped object according to the present embodiment example, first, molding data of the three-dimensional shaped object to be manufactured is input in the step S110 as shown by the flowchart of FIG. 7. There is no particular limit to the input source of the molding data of the three-dimensional shaped object and it is possible to input the molding data into the manufacturing device 1 of the three-dimensional shaped object with a PC or the like.

Next, the motor 6 is rotated to start moving the pellet 19 which is the constituent material from the hopper 2 to the ejector 10 in the step S120. As the motor 6 starts to rotate, the pellet 19 is melted by the heaters 7, 8, and 9 in the step S130. Then, the constituent material in the molten state that moved to the ejector 10 is ejected from the nozzle 10a in the step S140 so that the layer 24 is formed. The ejector 10 moves along with the layer formation in the step S140 so that, by the projection 23 being brought into contact with the layer 24 in the middle of formation as the ejector 10 moves along with the layer formation, the irregularity is formed in the layer 24 in the middle of formation in the step S150. Next, based on the molding data input in the step S110, it is determined in the step S160 whether the entire layer formation is over. When it is determined that the entire layer formation is not over, the process returns to the step S120 and the next layer 24 is formed. On the other hand, when it is determined that the entire layer formation is over, the method for manufacturing the three-dimensional shaped object according to the present embodiment example ends.

As described above, the method for manufacturing the three-dimensional shaped object according to the present embodiment example is the method for manufacturing the three-dimensional shaped object for manufacturing a three-dimensional shaped object by laminating the layer 24. The manufacturing method includes the melting step, corresponding to the step S130, of melting a thermoplastic constituent material, a layer formation step, corresponding to the step S140, of forming the layer 24 by using the ejector 10 moving while ejecting the constituent material in the molten state from the nozzle 10a, and the irregularity formation step, corresponding to the step S150, of forming the irregularity on the surface of the layer 24 in the lamination direction by causing the projection 23 which is the irregularity formation portion to come into contact with the constituent material in the molten state.

As described above, the method for manufacturing the three-dimensional shaped object according to the present embodiment example includes the irregularity formation step of forming the irregularity on the surface in the lamination direction of the layer 24 so that it is possible to suppress the adhesion failure by increasing the adhesion force due to the anchor effect between the respective layers. Further, in the method for manufacturing the three-dimensional shaped object according to the present embodiment example, the projection 23 comes into contact with the constituent material in the molten state so that it is possible to easily provide the irregularity in the constituent material in the soft state and there is also no need to execute a complicated ejection control. Therefore, in the method for manufacturing the three-dimensional shaped object according to the present embodiment example, it is possible to suppress the adhesion failure, without executing a complicated ejection control, between the respective layers at the time of manufacturing the three-dimensional shaped object by laminating the layer 24.

As described above, the ejector 10 is provided with the projection 23 around the nozzle 10a, and the irregularity is formed by causing the projection 23 to come into contact with the surface of the layer 24 in the irregularity formation step as the ejector 10 is moved in the layer formation step. Therefore, it is possible to shorten the distance between the nozzle 10a and the projection 23 which is the irregularity formation portion and to easily form the irregularity at the desired position in particular.

In other words, the manufacturing device 1 of the three-dimensional shaped object according to the present embodiment example is configured such that the projection 23 as the irregularity formation portion is formed around the nozzle 10a of the ejector 10 and that the projection 23 forms the irregularity by coming into contact with the surface of the layer 24 as the ejector 10 is moved to form the layer 24. Because of such a configuration, the manufacturing device 1 of the three-dimensional shaped object according to the present embodiment example can shorten the distance between the nozzle 10a and the irregularity formation portion and is configured to particularly easily form the irregularity at the desired position.

However, the present disclosure is not limited to such a configuration. In the following, the manufacturing device 1 of the three-dimensional shaped object according to an embodiment example 2 including the irregularity formation portion separately from the ejector 10 will be described.

### Embodiment Example 2 (Refer to FIGS. 8 and 9)

FIG. 8 is a schematic bottom view showing the ejector 10 of the manufacturing device 1 of the three-dimensional shaped object according to the present embodiment example and corresponds to FIG. 5 showing the ejector 10 of the manufacturing device 1 of the three-dimensional shaped object according to the embodiment example 1. Further, FIG. 9 is a schematic side sectional view showing the ejector 10 of the manufacturing device 1 of the three-dimensional shaped object according to the present embodiment example and shows the state immediately before the layer 24 of the nth layer is laminated on the layer 24 of the (n-1)th layer, corresponding to FIG. 6 showing the ejector 10 of the manufacturing device 1 of the three-dimensional shaped object according to the embodiment example 1. The constituting members shared with the embodiment example 1 described above will be denoted by the same reference symbols and the detailed description thereof will be omitted. Here, the manufacturing device 1 of the three-dimensional shaped object according to the present embodiment example is configured to be the same as the manufacturing device 1 of the three-dimensional shaped object according to the embodiment example 1 except that the irregularity formation portion 25 is included separately from the ejector 10.

As shown in FIGS. 8 and 9, the manufacturing device 1 of the three-dimensional shaped object according to the present embodiment example includes the irregularity formation portion 25 including, around the ejector 10, a plurality of the same projections as the semicircular projection 23a which is the projection 23 in the manufacturing device 1 of the three-dimensional shaped object according to the embodiment example 1. Then, the irregularity formation portion 25 is configured to move together with the ejector 10 and to form the irregularity on the surface of the layer 24 by causing the projection 23 to come into contact with the surface of the layer 24 as the ejector 10 is moved to form the layer 24. In this way, the manufacturing device 1 of the three-dimensional shaped object according to the present embodiment example includes the irregularity formation portion 25 separately from the ejector 10 so that the irregularity formation portion 25 is configured to move in the lamination direction with respect to the ejector 10 and it is possible to easily adjust the position of the projection 23 with respect to the layer 24 in which the irregularity is formed.

To describe from the viewpoint of the method for manufacturing the three-dimensional shaped object using the manufacturing device 1 of the three-dimensional shaped object according to the present embodiment example, the irregularity formation portion 25 in which the projection 23 is formed is provided around the ejector 10 so that it is possible to form the irregularity on the surface of the layer 24 in the irregularity formation step by causing the projection 23 to come into contact with the surface of the layer 24 as the ejector 10 is moved in the layer formation step. As long as the manufacturing device 1 of the three-dimensional shaped object according to the present embodiment example is used to execute the method for manufacturing the three-dimensional shaped object, the manufacturing device 1 of the three-dimensional shaped object according to the present embodiment example includes the irregularity formation portion 25 separately from the ejector 10 so that it is possible to easily adjust the position of the projection 23 with respect to the layer 24 in which the irregularity is formed.

The manufacturing device 1 of the three-dimensional shaped object according to the present embodiment example is configured to move the irregularity formation portion 25 with respect to the ejector 10 in the lamination direction. Therefore, there exists a gap G between the irregularity formation portion 25 and the ejector 10, but the gap G has an interval that the constituent material in the molten state hardly enters.

Further, in the manufacturing device 1 of the three-dimensional shaped object according to the present embodiment example, a total of 24 projections 23 is formed around the nozzle 10a at the interval of 15° with respect to the center of the nozzle 10a in the irregularity formation portion 25. Therefore, when the manufacturing device 1 of the three-dimensional shaped object according to the present embodiment example is used to form the layer 24, a plurality of the projections 23 among the 24 projections 23 come into contact with the layer 24. That is, as many as the number of recess portion 24a in coming into contact with the projections 23 are formed. FIG. 9 shows only two of the recess portions 24a formed by coming into contact with the plurality of projections 23.

Here, the size of the ejector 10 according to the present embodiment example will be described. The outer diameter length L6 of the ejector 10 is 1 mm. The inner diameter L7 of the nozzle 10a is 200 μm. In the projection 23, both the length in the protrusion direction corresponding to the lamination direction and the length L8 in the direction intersecting with the protrusion direction are 50 μm. The interval L9 between the tip of the projection 23 immediately before the layer 24 of the nth layer is formed on the surface of the layer 24 of the (n-1)th layer and the layer 24 of the (n-1)th layer is 100 μm, and the interval L10 between the ejector 10 and the layer 24 of the (n-1)th layer is 150 μm. The interval L10 between the ejector 10 and the layer 24 of the (n-1)th layer corresponds to the thickness of the respective layers of the layer 24.

Both the projections 23 in the manufacturing device 1 of the three-dimensional shaped object according to the embodiment examples 1 and 2 are semicircular projections 23a. However, the shape of the projection 23 is not limited to a semicircular shape. In the following, embodiment examples 3 and 4 of the manufacturing device 1 of the three-dimensional shaped object of which the shape of the projection 23 is not semicircular will be described.

### Embodiment Example 3 (Refer to FIG. 10)

FIG. 10 is a schematic side sectional view showing the ejector 10 of the manufacturing device 1 of the three-dimensional shaped object according to the present embodiment example and shows the state immediately before the layer 24 of the nth layer is formed on the layer 24 of the (n-1) th layer, corresponding to FIG. 6 showing the ejector 10 of the manufacturing device 1 of the three-dimensional shaped object according to the embodiment example 1. The constituting members shared with the embodiment examples 1 and 2 described above will be denoted by the same reference symbols and the detailed description thereof will be omitted. Here, the manufacturing device 1 of the three-dimensional shaped object according to the present embodiment example has the same configuration as the manufacturing device 1 of the three-dimensional shaped object according to the embodiment example 1 including the formation position of the projection 23 other than the shape of the projection 23.

The projection 23 in the manufacturing device 1 of the three-dimensional shaped object according to the present embodiment example has the form of the projection 23b which has a quadrangular frustum shape and of which the surface on the side of the smaller area of the two parallel surfaces is connected to the ejector 10, and the tip side widens. In this way, the projection 23 has a shape widening toward the tip portion such that, as shown in FIG. 10, the recess portion 24a formed by the projection 23 can be made into a key shape having a narrowing tip side so that it is possible to particularly strengthen the adhesion force due to the anchor effect between the respective layers and to effectively suppress the adhesion failure between the respective layers. The projection 23b according to the present embodiment example, of which the tip side widens, has a quadrangular frustum shape, and another example of the shape of which the projection 23 widens toward the tip portion includes a polygonal frustum shape other than the quadrangular frustum shape and a truncated cone shape.

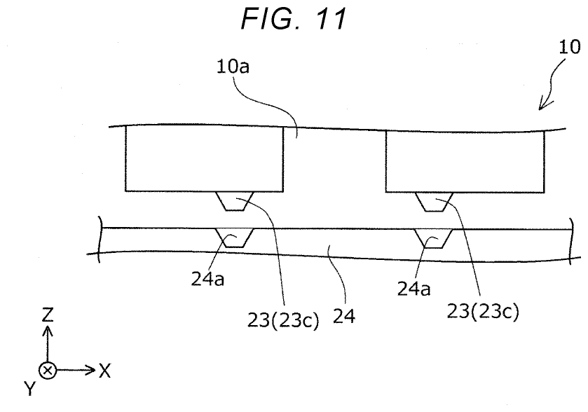

### Embodiment Example 4 (Refer to FIG. 11)

FIG. 11 is a schematic side sectional view showing the ejector 10 of the manufacturing device 1 of the three-dimensional shaped object according to the present embodiment example and show the state immediately before the layer 24 of the nth layer is formed on the layer 24 of the (n-1) th layer, corresponding to FIG. 6 showing the ejector 10 of the manufacturing device 1 of the three-dimensional shaped object according to the embodiment example 1. The constituting members shared with the embodiment examples 1 and 3 described above will be denoted by the same reference symbols and the detailed description thereof will be omitted. Here, the manufacturing device 1 of the three-dimensional shaped object according to the present embodiment example has the same configuration as the manufacturing device 1 of the three-dimensional shaped object according to the embodiment example 1, including the formation position of the projection 23 other than the shape of the projection 23.

The projection 23 in the manufacturing device 1 of the three-dimensional shaped object according to the present embodiment example has the form of the projection 23c which has a quadrangular frustum shape and of which the surface on the side of the larger area of the two parallel surfaces is connected to the ejector 10, and the tip side narrows. In this way, the projection 23 narrows toward the tip portion so that it is possible to simply manufacture the projection 23. In particular, the projection 23 in the manufacturing device 1 of the three-dimensional shaped object according to the present embodiment example has a quadrangular frustum shape and can be formed by the combination of planar surfaces so that it is possible to particularly easily manufacture the projection 23. The projection 23c, of which the tip side narrows, according to the present embodiment example has a quadrangular frustum shape, and another example of the shape of which the projection 23 narrows toward the tip portion includes a polygonal frustum shape other than the quadrangular frustum shape and a truncated cone shape.

The manufacturing device 1 of the three-dimensional shaped object according to the embodiment examples 1 to 4 is configured not to rotate the ejector 10 in the rotation direction as viewed from the lamination direction while the ejector 10 is configured to move 360° in the direction intersecting with the lamination direction. Therefore, the manufacturing device 1 of the three-dimensional shaped object according to any one of the embodiment examples 1 to 4 is configured such that the projection 23 is formed in the entire periphery of the ejector 10 as viewed from the lamination direction. However, the projection 23 can form the irregularity on the surface of the layer 24 as long as the projection 23 is downstream of the nozzle 10a in the moving direction of the ejector 10 so that, in the configuration in which the ejector 10 rotates in the rotation direction as viewed from the lamination direction and the moving direction of the ejector 10 is limited, the projection 23 may be downstream of the nozzle 10a in the moving direction of the ejector 10. In the following, an embodiment example 5 of the manufacturing device 1 of the three-dimensional shaped object in which the projection 23 is downstream of the nozzle 10a in the moving direction of the ejector 10 will be described.

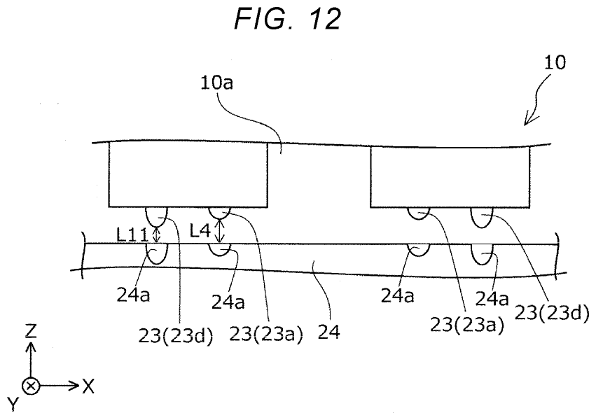

### Embodiment Example 5 (Refer to FIG. 12)

FIG. 12 is a schematic side sectional figure showing the ejector 10 of the manufacturing device 1 of the three-dimensional shaped object according to the present embodiment example and shows the state immediately before the layer 24 of the nth layer is formed on the layer 24 of the (n-1) th layer, corresponding to FIG. 6 showing the ejector 10 of the manufacturing device 1 of the three-dimensional shaped object according to the embodiment example 1. The constituting members shared with the embodiment examples 1 to 3 described above will be denoted by the same reference symbols and the detailed description thereof will be omitted. Here, the manufacturing device 1 of the three-dimensional shaped object according to the present embodiment example is configured such that the ejector 10 can rotate in the rotation direction as viewed from the lamination direction and the projection 23 is positioned downstream of the nozzle 10a in the moving direction of the ejector 10. The configuration other than such a configuration is the same as the configuration of the manufacturing device 1 of the three-dimensional shaped object according to the embodiment example 1.

In the manufacturing device 1 of the three-dimensional shaped object according to the present embodiment example, as viewed from the direction intersecting with the lamination direction as shown in FIG. 12, two semicircular projections 23a are formed on the side close to the nozzle 10a and two semicircular projection 23d, of which the projection length is longer than the semicircular projections 23a, are formed on the side away from the nozzle 10a. In other words, an interval L11 between the tip of the projection 23d and the layer 24, which is shorter than the interval L4 between the tip of the projection 23a and the layer 24, is formed on the outer side in the ejection width direction. The moving direction of the ejector 10 in FIG. 12 is the Y-direction. Then, the manufacturing device 1 of the three-dimensional shaped object according to the present embodiment example moves the ejector 10 in the direction intersecting with the lamination direction while rotating the ejector 10 to eject the constituent material from the nozzle 10a so that it is possible to form the irregularity on the surface of the layer 24 while forming the layer 24 while positioning the projection 23 downstream of the nozzle 10a in the moving direction of the ejector 10.

That is, the manufacturing device 1 of the three-dimensional shaped object according to the present embodiment example has, as the projection 23, the projection 23a which is the first projection and the projection 23d which is the second projection which is farther from the nozzle 10a than the projection 23a and of which the length in the protrusion direction is longer than the projection 23a. If the constituent material in the molten state flows in the ejection width direction from the nozzle 10a, the sectional shape is rounded and the rounded constituent material is adjoined so that a concern that a space is generated in the adjoining portion arises. However, the manufacturing device 1 of the three-dimensional shaped object according to the present embodiment example is configured such that, by the projection 23d of which the length is longer than the projection 23a in the protrusion direction, it is possible to effectively suppress the rounding of the end portion in the ejection width direction caused by the excessive flowing of the constituent material in the molten state in the ejection width direction when the layer 24 is formed and that it is possible to suppress the generation of the space in the adjoining portion of the constituent material.

The present disclosure is not limited to the embodiment examples described above and can be realized in various configurations within a range not deviating from the scope of the disclosure. The technical features in the embodiment examples corresponding to the technical features of the respective aspects described in the summary of the disclosure can be appropriately replaced or combined in order to resolve some or all of the problems described above or to achieve some or all of the effects described above. Further, the technical features can be appropriately removed as long as the technical features are not described as indispensable in the present specification.

What is claimed is:

1. A device for manufacturing a three-dimensional shaped object for manufacturing a three-dimensional shaped object by laminating layers, the device comprising:
a melting unit melting a thermoplastic constituent material;
an ejector having a nozzle and moving while ejecting the constituent material in a molten state from the nozzle to form the layers; and
an irregularity formation portion forming an irregularity on a surface in a lamination direction of the layers by coming into contact with the constituent material in the molten state.

2. The device for manufacturing a three-dimensional shaped object according to claim 1, wherein
the ejector is provided with a projection as the irregularity formation portion around the nozzle and
the projection forms the irregularity by coming into contact with the surface as the ejector is moved to form the layer.

3. The device for manufacturing a three-dimensional shaped object according to claim 1, wherein
the irregularity formation portion in which the projection is formed is provided around the ejector and
the irregularity formation portion forms the irregularity by causing the projection to come into contact with the surface as the ejector is moved to form the layers.

4. The device for manufacturing a three-dimensional shaped object according to claim 2, wherein
the projection is subjected to a surface treatment for suppressing adhesion of the constituent material in a molten state.

5. The device for manufacturing a three-dimensional shaped object according to claim 2, wherein
the projection is formed in a curved surface.

6. The device for manufacturing a three-dimensional shaped object according to claim 2, wherein
the projection widens toward a tip portion.

7. The device for manufacturing a three-dimensional shaped object according to claim 2, wherein
the projection narrows toward a tip portion.

8. The device for manufacturing a three-dimensional shaped object according to claim 2, wherein
an outer diameter of the projection in a direction intersecting with the protrusion direction of the projection is narrower than an inner diameter of the nozzle.

9. The device for manufacturing a three-dimensional shaped object according to claim 2, wherein
the projection includes a first projection and a second projection which is farther from the nozzle than the first projection and of which a length is longer than the first projection in a protrusion direction.

10. A method for manufacturing a three-dimensional shaped object for manufacturing the three-dimensional shaped object by laminating layers, the method comprising:
a melting step of melting a thermoplastic constituent material;
a layer formation step of forming layers by using an ejector moving while ejecting the constituent material in a molten state from a nozzle; and
an irregularity formation step of forming an irregularity on a surface in a lamination direction of the layers by causing an irregularity formation portion to come into contact with the constituent material in the molten state.

11. The method for manufacturing a three-dimensional shaped object according to claim 10, wherein
the ejector is provided with a projection around the nozzle, and
in the irregularity formation step, the projection is caused to come into contact with the surface to form the irregularity in the irregularity formation step as the ejector is moved in the layer formation step.

12. The method for manufacturing a three-dimensional shaped object according to claim 10, wherein
an irregularity formation portion in which a projection is formed is provided around the ejector, and
in the irregularity formation step, the projection is caused to come into contact with the surface to form the irregularity in the irregularity formation step as the ejector is moved in the layer formation step.
